(19) United States
(12) Patent Application Publication
(10) Pub. No.: US 2021/0137084 A1
(43) Pub. Date: May 13, 2021

(54) COMBINATION LURE

(71) Applicant: KOPPERS FISHING AND TACKLE CORP., Niagara-on-the-Lake (CA)

(72) Inventors: Grant Koppers, Niagara-on-the-Lake (CA); Tobias Wiegand, Niagara-on-the-Lake (CA)

(21) Appl. No.: 17/254,769

(22) PCT Filed: Jun. 27, 2019
(86) PCT No.: PCT/CA2019/000099

§ 371 Date: Dec. 21, 2020

Related U.S. Application Data
(60) Provisional application No. 62/694,607, filed on Jul. 6, 2018.
(60) Provisional application No. 62/803,707, filed on Feb. 11, 2019.

(51) Int. Cl. A01K 85/00; B29C 45/16

(52) U.S. Cl. CPC A01K 85/00; B29C 45/1679; B29L 2031/7002; B29K 2995/002; B29C 45/1671

(57) ABSTRACT

A lure includes one or more cores having a surface shape and coloration configured to represent an anatomy of a food for a game fish with one or more outer portions of translucent material disposed thereabout. The outer portion is at least partially flexible with one or more outer fins and/or tails configured to cause the lure to move through water in conformance with a mode of transit. The core presents a three-dimensional appearance of a schooling baitfish, a bottom baitfish, a crustacean, an amphibian, a worm, a grub, an insect, a spider, a leech, or another creature that is attractive to fish. The core may include a surface shape and/or coloration that represents a mouth, an eye, a fin, and/or one or more gills or opercles. The core may be formed around a rigid object such as a hook, a line leader, or a weight.

### CROSS REFERENCE TO RELATED APPLICATIONS

This U.S. utility patent application claims the benefit of U.S. provisional patent application No. 62/803,707, filed Feb. 11, 2019, the contents of which is incorporated herein by reference in its entirety.

### FIELD

The present disclosure relates to improved lures and methods of making lures.

### BACKGROUND

Fishing for sport or for food is a popular outdoors activity. Lures, which may also be called artificial lures to distinguish from live bait, are commonly used for fishing. Lures can be effective in attracting fish to bite a hook and resulting in a successful catch. An angler may keep and use numerous different types of lures, with some types of lures being more effective for catching particular types of game fish, and/or with some types of lures being more effective at certain times. For example, a lure that mimics the look and/or behavior of a particular food source may be especially effective for catching particular type of sport fish or game fish at a particular location and/or at a particular season and/or time of day.

Artificial lures may be used in conjunction with other tackle, such as weights, lines, bobbers, hooks, etc. to produce a particular action or effect and to improve the chances of successfully catching a particular type of fish.

### SUMMARY

A lure comprises a core having a surface shape and coloration configured to represent an anatomy of a food for a game fish. The lure also comprises an outer portion of translucent material disposed around the core. The outer portion is at least partially flexible and defines a surface that is adapted to cause the lure to move in conformance with a mode of transit as the lure is moved through water.

### BRIEF DESCRIPTION OF THE DRAWINGS

Further details, features and advantages of designs of the invention result from the following description of embodiment examples in reference to the associated drawings.

FIG. 1 is a schematic perspective diagram of a combination lure in accordance with various aspects and embodiments of the invention.

FIG. 2 is a schematic perspective diagram showing a first stage in producing a combination lure in accordance with various aspects and embodiments of the invention;

FIG. 3 is a schematic perspective diagram showing a second stage in producing a combination lure in accordance with various aspects and embodiments of the invention;

FIG. 4 is a side view of a Twitch Minnow lure in accordance with various aspects and embodiments of the invention;

FIG. 5 is a side view of a Skip Shad lure in accordance with various aspects and embodiments of the invention;

FIG. 6 is a perspective view of a core of the Skip Shad lure of FIG. 5;

FIG. 7 is a perspective view of an outer layer of the Skip Shad lure of FIG. 5;

FIG. 8 is a perspective view of the combined core and outer layers of FIGS. 6-7;

FIG. 9 is a side view of the lure of FIG. 5 with a hook attached thereto in a Neko rig or wacky rig configuration;

FIG. 10 is a side view of the lure of FIG. 5 with a hook, line and sinker assembly in a first Drop Shot configuration;

FIG. 11 is a top view of the lure of FIG. 5 with a hook, line and sinker assembly in a second Drop Shot configuration;

FIG. 12 is a perspective view of the lure of FIG. 5 with a hook in a Jerk configuration;

FIG. 13 is a perspective view of the lure of FIG. 5 with a hook, line and sinker assembly in a Leaderless Drop Shot configuration;

FIG. 14 shows a flow chart of steps in a first method of making a lure in accordance with some embodiments of the present disclosure; and

FIG. 15 shows a flow chart of steps in a second method of making a lure in accordance with some embodiments of the present disclosure.

### DETAILED DESCRIPTION

Referring to the drawings, the present invention will be described in detail in view of following embodiments. In various aspects and embodiments the present disclosure provides improved lures, and other types of combination devices, particularly combination moldings; and methods of producing them. Among the many advantages offered by the invention is the possibility of providing highly realistic lures for fishing and other sports, and thereby increase the effectiveness and efficiency of their use.

In one aspect, for example, the invention provides a lure 10 comprising one or more cores 12 that are wholly-opaque or partially-opaque and which resemble fish, bugs, worms, and/or other types of forage attractive to fish, or portions thereof. Such cores 12 are enclosed in one or more outer portions 14 that are wholly or partially-translucent. The shape of one or more of the outer portions 14 may wholly or partially conform, or not conform, to the shape of one or more cores 12. For example, one or more translucent outer portions 14 may deviate from conformance with the shape of one or more of the cores 12 by inclusion of outer fins 22′, outer tails 24′ and/or other objects that affect the fluid-dynamic response of the lure 10, for example when the lure 10 is pulled through the water on a fishing line.

It is important to note that any or all of one or more of the cores 12 and/or one or more of the outer portions 14 can be molded or otherwise formed in one or more pieces. For example, a core 12 can comprise multiple components, so as to represent for example plurality of baitfish encased within a single outer portion 14, with features configured to provide any desired hydrodynamic response as the lure 10 is moved through water or other fluid.

Each of one or more of the cores 12 of the subject lure 10 comprises a generally opaque object representing an anatomy of a real or imaginary species of fish, bug, worm or other creature attractive to fish as food. Such species can, for example, represent any of a schooling baitfish, such as a shad, shiner, herring, sardine, smelt, anchovy, alewife, or minnow; a bottom baitfish, such as a dace, goby, sculpin, darter, minnow, chub, or sucker; a crustacean, such as a crawfish, shrimp, or crab; an amphibian, such as a frog, toad, salamander, lizard, newt, or mudpuppy; a worm, grub, insect, or other small ground creature; aquatic creature such as a squid or octopus; a small mammal such as a mouse, vole, or rat; a leech; or any other creature attractive to one or more fish an angler or other person might wish to catch for game, food, or other purpose. In various embodiments, one or more of the cores 12 are formed in a three-dimensional shape, so as to accurately resemble the anatomy of an attractive food for fish. In some embodiments, a two-dimensional (flat) embodiment will suffice.

Suitable materials for fabrication of lures 10 in accordance with the invention can include a wide variety of relatively soft, or flexible substances, and/or relatively rigid substances. Examples of relatively flexible substances include various grades of polyvinyl chloride (PVC), thermoplastic elastomers (TPE(s)), and/or thermoplastic rubbers (TPRs). Examples of relatively rigid substances include various grades of polyvinyl chloride (PVC), acrylonitrile butadiene styrene (ABS), and/or polycarbonate materials. Any or all of such materials can range in Shore hardness (or Shore durometer reading) from extremely soft and pliable to extremely hard and rigid. Lures made from such materials, and their various cores 12 and/or outer portions 14 can be fabricated so as to have varying degrees of Shore hardness in various parts of their volumes, in order to achieved desired behavior effects.

In various embodiments, either or both of the cores 12 and/or the outer portions 14 are formed of flexible materials such as silicone or other soft polymers, and are fabricated through the use of molding processes such as injection molding. In various embodiments, all or various portions of or the outer portions 14 may be formed of flexible material(s) in combination with rigid materials such as ABS so that some portions are flexible and others relatively rigid. The use of flexible materials, optionally in combination with rigid portions provides a number of advantages, so that for example when a lure 10 is moved through water or other fluids it can flex and thereby take on a realistic resemblance to a living, moving fish, shrimp, or other creature, and thereby enhance its attractiveness to game fish, etc.

For the same and other reasons, some or all parts of the cores 12 can also be fabricated using flexible materials such as silicone, in order to enhance the realistic or otherwise attractive appearance and action of the lure 10, etc. Alternatively, the cores 12 may be made entirely of rigid materials such as ABS, or may be made of combinations of flexible and relatively rigid materials. For at least the same reasons, as will be understood by those skilled in the relevant arts, some or all part of the cores 12 and/or the outer portions 14 can be provided in wholly or partially rigid form. For example, the use of partially flexible, partially rigid lures can provide highly realistic representations of crabs, crawfish, shrimp, and other creatures, and can be used to tailor fluid dynamic responses, and motions, as the lure 10 is are pulled through water or other fluids.

In further embodiments, either or both of the cores 12 and/or the outer portions 14 are fabricated wholly or partially using relatively rigid material such as acrylonitrile butadiene styrene (ABS) or other forms of polymers. The lure 10 can, for example, be fabricated by sequentially molding the outer portions 14 around all or part of one or more of the cores 12.

Buoyancies or densities of various portions of one or more of the cores 12 and/or one or more of the outer portions 14 can also vary as desired in order to achieve desired effects or behaviors in water or other fluids. For example, all or any part or parts of one or more of the cores 12 can be fabricated using materials providing a first buoyancy, or range of buoyancies, while all or any part or parts of one or more of the outer portions 14 can be fabricated of differing materials, so as to provide differing buoyancies, as desired.

A lure 10 comprising a core 12 having a surface shape and coloration configured to represent an anatomy of a food for a game fish is shown in FIG. 1. The core 12 may have an appearance of a plant or animal, or a portion thereof. The lure 10 also comprises an outer portion 14 of translucent material disposed around the core 12. In some embodiments, the outer portion 14 is sufficiently translucent to not significantly distort an appearance of the core 12 when viewed in air or water. The outer portion 14 is at least partially flexible and defines a surface that is adapted to cause the lure 10 to move in conformance with a mode of transit as the lure 10 is moved through water. For example, the lure 10 may move with a regular oscillation to mimic swimming of a fish or kicking/flicking motion to mimic swimming or hopping by an amphibian such as a frog or a toad. The mode of transit may also include a jigging motion that includes periodic and alternating motion of the lure 10 which may be attractive to fish. Such jigging motion may include vertical movement (i.e. lifting and dropping) and/or horizontal movement (i.e. side-to-side).

One or more of the outer portions 14 can be molded or otherwise formed around one or more cores 12. The outer portions 14 can be wholly or partially translucent, so as to enable wholly or partially-opaque cores 12 to be seen from outside the lure 10 when disposed in air, water, or other fluid, so as, for example, to attract fish or other game. In some embodiments, either or both of one or more of the cores 12 and/or one or more of the outer portions 14 can be formed wholly or partially of translucent material. In various embodiments, one or more of the cores 12 are generally less translucent than one or more of the outer portions 14, but either or both of the core 12 and/or the outer portion 14 can be at least partially opaque, or of any degree of translucence. In general, but not in all cases, one or more of the outer portions 14 are relatively more translucent than one or more of the cores 12. Thus, for example, the core 12, which can for example represent a fish, bug, or crustacean in order to serve as bait, may be relatively more prominent in view than intervening or otherwise corresponding outer portions 14. For example, parts of an outer portion 14 adjacent to one or more of the cores 12 can be relatively more translucent, in order to enable fish or other viewers to perceive one or more of the cores 12, while other parts of one or more of the outer portions 14, such as a fin or other device, can be more opaque.

Either or both of the core 12 and/or the outer portion 14 can comprise powders, oils, or scents or chemical or mechanical attractants. Such powders and/or oils can be infused or otherwise added to the materials used to form the cores 12 and/or the outer portions 14 prior to injection or other molding processes, and/or an oil can be applied or otherwise added to the lure 10 after the outer portion 14 is formed and prior to packaging.

In some embodiments, one or more of the cores 12 presents a three-dimensional appearance of a schooling baitfish, a bottom baitfish, a crustacean, an amphibian, a worm, a grub, an insect, a spider, a leech, or another creature that is attractive to fish. The surface shape and coloration of one or more of the cores 12 may represent an anatomical feature of a creature. For example, as shown in FIG. 1, the core 12 may include a surface profile shape and/or coloration that represents one or more of a mouth 13, an eye 16, one or more inner fins 22, one or more inner tails 24, and/or one or more gills or opercles 28. Additionally or alternatively, one or more of the cores 12 may include a surface profile shape and/or coloration representing other anatomical features such as, for example, one or more wings, arms, legs, lateral lines, scales, fur, or a shell. The surface shape and/or coloration of one or more of the cores 12 may comprise one or more of: paint, one or more metallic flakes or pieces, or glitter.

All or part of one or more of the cores 12 can comprise paint, ink, or other materials to color or otherwise affect the external appearance of the lure 10. For example, the belly portion of a lure 10 that is fish-shaped can comprise glitter or other shiny flakes to give a more or less opaque and glittering appearance to one or more portions of the external surface while allowing other portions, such as the head of the fish, to be provided by one or more of the cores 12 and seen through the translucent outer portion 14 of the lure 10. Tips of fins, tails, wings, and/or other appendages may also be painted to enhance their visibility, realistic appearance, etc.

In various embodiments, all or at least a portion of an outer surface of one or more of the cores 12 may be painted or otherwise colored in order to help effect the likeness of the representation to baitfish or other foods. In some embodiments the entire surface of one or more of the cores 12 is colored; in others only portions of the surface are colored. In addition to paints, stickers, decals, and other two-dimensional physical markings may be applied; surface printing techniques may also be used to apply various types of inks, etc.

In some embodiments, one or more of the cores 12 may be formed with few or no painted or other representations of anatomical markings. For example, in some embodiments one or more of the cores 12 can be formed to include only basic anatomical features, such as a basic shape of a fish, bug, or insect formed in one or two colors, and without painted, printed, or otherwise-formed anatomical details, and enclosed in the translucent outer portion 14 as described herein. Such embodiments can, for example, represent the profile of a fish, worm, crustacean, etc. more or less accurately, but without differentiated colors, etc., representing scales, fins, bones, or other types of anatomical features.

In some embodiments, one or more portions of one or more of the cores 12 can be formed of translucent material, for example, to enhance the likeness to food creatures attractive to fish. It should be noted that ‘translucent’ herein, means transparent or otherwise adapted to transmit some or all wavelengths of light visible to humans, fish, or other creatures. Translucent objects can be clear (i.e., transmit all relevant visible wavelengths) and/or can selectively transmit one or more wavelengths, so that translucent objects in accordance with various aspects and embodiments can be uniformly colored, or have multi-colored appearances, as desired.

One or more of the cores 12 can be molded or otherwise formed to include specific anatomical features, such as eyes, fins, scales, lateral lines, opercles, arms, legs, fur, or tails, etc.; and/or such features can be represented by two-dimensional coloration such as painting or molding using multiple materials of varying, desired colors. Optionally metallic flakes, parts, or other solid or granular objects such as glitter can be molded into, adhered to, or otherwise incorporated as surface coloration. In other embodiments one or more of the cores 12 may be shaped and/or adorned with surface coloration to represent any useful natural, artistic or utilitarian object.

In some embodiments, one or more of the cores 12 and/or one or more of the outer portions 14 can be molded around, or otherwise formed so as to include, embedded objects such as fish hooks 17 or other hooks 17, line leaders 18, weights 19, structural wires or supports, air cavities, magnets, or other objects. More specifically, one or more of the cores 12 may be formed around a rigid object 17, 18, 19. For example, as shown in FIG. 1, the rigid object 17, 18, 19 may include one or more of a hook 17, a line leader 18, and one or more weights 19. The hook 17 may include one or more points or barbs. The line leader 18 may include an eyelet for attachment of a line or other hardware for moving the lure 10 through water. In some embodiments, the hook 17 and the line leader 18 may be combined as a single object.

In some embodiments, and as shown in FIG. 1, one or more of the cores 12 may define one or more chambers 20. For example, one or more of the cores 12 may be formed around a hollow structure, such as plastic or metal, to define the chamber 20. Alternatively or additionally, one or more of the chambers 20 may be a simple void within a corresponding one of the cores 12 without any additional structure. One or more of the chambers 20 may be filled with air, which may add buoyancy to the lure 10. Alternatively or additionally, one or more of the chambers 20 may hold one or more weights 19, such as ball bearings. For example a steel ball bearing inside a small metal tube or cylindrical chamber 20 can be provided in order to create a knocking or rattling sound, for example low-frequency rattle sound as the lure 10 tilts or rolls while in use. One or more ball bearings or other weights 19 can also be configured to act as weight-transfers when an angler is attempting to cast the lure 10 long distances or into direct headwinds. In such embodiments one or more ball bearing weights 19 can rolls to the end of an embedded chamber 20 (e.g., at the tail section) and the additional weight can help to propel the lure 10 straighter, and ultimately further, upon being cast.

The outer portion 14 can generally correspond, or not correspond, to a shape of one or more of the cores 12. For example, an outer portion 14 can be formed of a relatively thin layer of translucent material over all or any portion of a single core 12, so as to closely conform to the external shape of at least a part of the inner portion; or some or all of the outer portion 14 can have a non-conforming external shape. For example, as shown in FIG. 1, an exterior surface of an outer portion 14 can comprise an outer tail 24′, one or more outer fins 22′, and other features, so as to provide fluid dynamic features, such as control surfaces which can affect the motion of the lure 10 when the lure 10 is pulled or otherwise moved through water or other fluid. Such features can, for example, cause the outer tail 24′ to move side to side as if propelling the lure 10, and/or the outer fins 22′ can cause the lure 10 to rise, drop, turn, oscillate, etc. Thus, for example, the outer portion 14 can comprise features not corresponding to the external surface or shape of core 12, including wings, flanges, flaps and other mechanical shapes used to guide the exterior to generate a particular action.

In various embodiments, the outer portion 14 may be formed to include anatomical markings such as eye “bulges” or outer fins 22′ that protrude from the outer portion 14 and align with corresponding anatomical markings on the core 12. For example, an eye 16 may be painted or applied (using for example a sticker or decal) on a surface of the core 12, and a corresponding region of an outer portion 14 can be formed to include a bulge representing a lens or other portion of the eye 16.

In some embodiments, the outer portion 14 comprises a physical feature not comprised or represented by any of the cores 12. For example, as shown in FIG. 1, the outer portion 14 may include one or more outer fins 22′ and/or one or more outer tails 24′. The outer fins 22′ and/or the outer tails 24′ may be configured to cause the lure 10 to move through water in conformance with the mode of transit. Additionally or alternatively, the outer portion 14 may include other physical features such as a wing, flange, flap or other hydrodynamic or mechanical fluid control surface. The outer portion 14 may include coloration adapted to affect a surface appearance of at least a portion of the lure 10. For example, the coloration may comprise one or more of paint, one or more metallic flakes or parts, and/or glitter.

In some embodiments, at least a portion of one or more of the cores 12 is flexible. For example, one or more of the cores 12 may be wholly or partially made of a soft polymer material. Additionally or alternatively, the outer portion 14 may be wholly or partially made of a soft polymer material. In some embodiments, one or both of the core or cores 12 and/or the outer portion or portions 14 may define a durometer gradient. In some examples lures 10, either or both of one or more of the cores 12 and/or one or more of the outer portions 14 may be formed so as to have a varying rigidity along their lengths, widths, etc. Such a durometer gradient may provide for hydrodynamic purposes and/or for other purposes, such as causing the lure 10 to moving through water in conformance with a mode of transit.

The lures 10 of the present disclosure may be used in various different rigs or configurations, which may be new and/which may be known or used with conventional bait or conventional lures. For example, FIGS. 4-13 present several different configurations for using a lure 10 of the present disclosure.

FIG. 4 is a side view of an example lure 10 having the form of a Twitch Minnow in accordance with some embodiments. FIG. 5 is a side view of an example lure 10 having the form of a Skip Shad in accordance with some embodiments. FIG. 6 is a perspective view of a core 12 of the Skip Shad lure 10 of FIG. 5. FIG. 7 is a perspective view of an outer portion 14 of the Skip Shad lure 10 of FIG. 5. and FIG. 8 is a perspective view of the combined core 12 and outer portion 14 of the Skip Shad lure 10 of FIGS. 6-7.

FIG. 9 is a side view of the lure 10 of FIG. 5 with a hook attached thereto in a Neko rig or a wacky rig configuration. FIG. 10 is a side view of the lure 10 of FIG. 5 with a hook 17, line 40, and sinker 38 in a first Drop Shot configuration. FIG. 11 is a top view of the lure 10 of FIG. 5 with a hook 17, line 40, and sinker 38 assembly in a second Drop Shot configuration. FIG. 12 is a perspective view of the lure 10 of FIG. 5 with a hook 17 in a Jerk configuration. FIG. 13 is a perspective view of the lure 10 of FIG. 5 with a hook 17, line 40, and sinker 38 assembly in a Leaderless Drop Shot configuration.

As shown in FIGS. 4-13 the encapsulated lure 10 of the present disclosure may present a fish within a fish, rather than simply a different color of soft plastic within another color of plastic. One or more of the cores 12, which may be called an “inner fish,” has realistic color, texture and/or anatomical patterns that are protected by one or more of the outer portions 14, which may be called an “outer fish” or “exoskin.” One or more of the outer portions 14 may be formed from a clear plastic. As a result, the colors and scale patterns on one or more of the cores 12 may be protected from being rubbed or scratched off while the lure 10 is being drawn through a body of water containing stones, branches and other objects, nor when struck by a game fish. The external anatomy of one or more of the cores 12 may be carried over, at least in part, on one or more of the outer portions 14. The transparent outer portion or portions 14 may envelop or encapsulate the core or cores 12.

In some embodiments, features of one or more of the outer portions 14 may be substantially aligned with and replicate corresponding anatomical features on more of the cores 12, but without any color added (i.e. one or more of the outer portions 14 may be translucent or transparent). A three-dimensional effect may be created by alignment of features on more of the cores 12 and one or more of the outer portions 14. Coloration, such as paint on more of the cores 12 may create a substantial amount of flash or reflectivity due to the anatomical features such as gills or opercles 28, eyes 16, the scale pattern, and the like. Furthermore, more of the cores 12 may be soft and flexible which may have with iridescent coloring that can enhance the reflectivity of the lure 10.

The density of one or more of the cores 12 and one or more of the outer portions 14 can be modulated to provide a desirable action as the lure 10 moves through water and to provide a balance that enables the lure 10 to, for example, fall through water with a shimmy movement that mimics a real baitfish without tumbling or spiraling. The present lure 10 is versatile with respect to the manner in which a hook 17, sinker 38 and line 40 may be disposed thereon. For instance, the Skip Shad illustrated in FIG. 12 may be a jerk bait in a “lay down” pattern that replicates an injured Shad or Sardine with tantalizing action. It can be used as a soft jerk bait or customized to several techniques. Dropshot rigs are illustrated in FIGS. 10, 11 and 13. A wacky rig is illustrated in FIG. 9. Weedless Texas Rigged, Stand-up Jig and other configurations are also possible. These lures 10 may be particularly well suited for skipping under docks and cover.

A first method 100 of making a lure 10 is shown in the flow chart of FIG. 5. The first method 100 includes disposing a molding frame 30, 32 in a first molding device at step 102. The first molding device may include, for example, an injection molding die defining a shape for the core 12. The molding frame 30, 32 comprises at least a first molding support member 30 and at least one second molding support member 32, with the first and second molding support members 30, 32 being non-collinear and/or non-coaxial. In some embodiments, the second molding support members 32 are disposed in one or more planes at generally right angles to the first molding support member 30. Specifically, and shown in FIGS. 2-3, the molding frame 30, 32 may comprise the first molding support member 30 configured to extend longitudinally within the lure 10, and the one or more second molding support members 32 disposed substantially orthogonally to the first molding support member 30.

In some embodiments, the first method 100 may include disposing an embedded object, such as fish hooks, weights, line leaders, structural wires or supports, air cavities, magnets, or other objects in the first molding device at step 103. The embedded object may be disposed prior to introducing the first material at step 104, or after introducing the first material at step 104 and before solidifying the core 12 at step 106. The embedded object thus becomes embedded within the solidified core 12.

The first method 100 proceeds with introducing a first material to the first molding device at step 104. The first material may be introduced via injection molding or by another technique. More specifically, one or more first materials, such as one more grades of silicone of one or more colors, can be injected into the mold, so that the first materials fill the mold cavity and encase the molding frame 30, 32 and any embedded objects that were disposed in the mold prior to this step 104.

In some embodiments, the mold cavity (not shown) can be formed after all desired molding support members 30, 32 and/or any embedded objects are in place within the mold. For example, the mold cavity can be formed by closing or clamping two or more mold segments together. The formed mold cavity thus provides for injection of the first materials to fill the cavity and, upon setting form a flexible or rigid (or partially flexible, partially rigid) two-dimensional or three-dimensional core 12 in the shape of a useful first object, such as a fishing lure. As mentioned above, cores 12 can be molded into shapes representing any natural, artistic, or utilitarian objects, such as fish with eyes, fins, opercles, lateral line, scales, etc.

In some embodiments, the first method 100 may include introducing one or more colorants to the first molding device at step 105. For example, each of the one or more colorants may have a different color to generate a surface coloration of the core 12 with the surface coloration representing an anatomical feature of a creature attractive to fish as food. The colorants may be introduced as a coating that may form an outer surface of the core 12. Additionally or alternatively, the colorants may be disposed within the first material or materials to cause the core 12 to has an integral coloration.

As further explained above, surfaces of cores 12 can be provided with both three-dimensional figures and coloration schemes, so that the cores 12 provide more or less realistic representations of fish, other animals, and other objects. One way of providing some or all of such coloration is by the use of multiple injection ports in such molds, so that the injection of multiple material streams of differing colors can be used to provide desired surface appearances. Alternatively, or in addition, molded cores 12 can be painted or otherwise provided with desired color schemes. Various types and forms of glitter, metal flake, etc., can be used to enhance realism and other aspects of coloration

The first method 100 also includes solidifying the first material to form the core 12 at step 106. The first material may solidify as it cools, which may be facilitated with a cooling fluid that is circulated through the first molding device. Alternatively or additionally, the first material may solidify via a chemical reaction that may be initiated by exposure to water or another chemical reactant. An example of the core 12 with the molding frame 30, 32 is shown in FIG. 2. Solidifying may include becoming a solid. Alternatively, solidifying may include wholly or partially forming a semi-solid material having a predetermined shape. For example, all or part of the core 12 may be a flexible semi-solid with a predetermined shape defined by the first molding device.

The first method 100 also includes disposing the molding frame 30, 32 and the core 12 in a second molding device at step 108. The second molding device may include, for example, an injection molding die defining a shape for one or more of the outer portions 14. The molding frame 30, 32 may function to hold the core 12 at a predetermined position within the second molding device.

The first method 100 also includes introducing a second material to the second molding device at step 110. The second material to the second molding device thus forms the outer portion 14 at least partially surrounding the core 12. The second material may be introduced via injection molding or by another technique. The cavity of the second molding device can, as explained above, be configured to closely conform to some or all of the core 12, or to provide distinct features so as, for example, to impart desired hydro-dynamic or other fluid-dynamic properties to the fishing lure 10 when moving relative to water or other fluids. Such features can for example include any or all of outer fins 22′, outer tails 24′, wings flanges, flaps or other hydrodynamic or mechanical fluid control surfaces.

In summary, a working assembly such as shown in FIG. 2 results when the core 12 has set and any desired surface coloration or other treatment has been applied. The working assembly, which includes the molding frame 30, 32, the core 12, and any embedded objects, can be placed in a second molding device, and one or more second materials can be injected or otherwise introduced around the core 12, so as to encompass all or any desired portions of the surface of the core 12 in a second layer, or outer portion 14, as shown in FIGS. 1 and 3.

The first method 100 also includes removing at least one of the molding support members 30, 32 from at least one of the core 12 and/or the outer portion 14 at step 112. The molding support members 30, 32 may be fully or partially removed from the core 12 and/or the outer portion 14. For example, one or more of the molding support members 30, 32 can be pulled or otherwise mechanically withdrawn, or chemically dissolved, etc. Any suitable method, or combination of methods, will serve, resulting in product such as shown in FIG. 1. Removing at least one of the molding support members 30, 32 may leave residual holes in either or both of the core 12 and/or the outer portion 14. Such residual holes may be filled-in using subsequent injections of silicones or other materials as desired.

Thus in various aspects and embodiments the invention provides methods of making a combination fishing lure 10, comprising disposing a molding frame 30, 32 in a first molding device, the molding frame 30, 32 comprising at least a first molding support member 30 and at least one second molding support member 32, the first and second molding support members 30, 32 being at least one of non-collinear and non-coaxial; introducing a first material to the first molding device and allowing it to set, so as to form a core 12; disposing the molding frame 30, 32 and the core 12 in a second molding device; and introducing at least one same or different material to the second molding device, so as to form an outer portion 14 wholly or partially encompassing the core 12.

As explained above, through the use of suitable molding materials, such as soft forms of silicon or other polymers, etc., either or both of the core 12 and/or the outer portion 14 can be wholly or partially flexible when set, and can include varying degrees or gradations of flexibility in different regions, or order to obtain desired fluid dynamic or other properties. As further explained above, the outer portion 14 can comprise at least partially translucent portions and optionally wholly or partially opaque regions, in order to provide desired surface appearances to the fishing lure 10.

A second method 200 of making a lure 10 is shown in the flow chart of FIG. 6. The second method 200 includes introducing a settable material to an interior of an outer portion 14 of flexible translucent material at step 202.

The second method 200 proceeds with solidifying the settable material to form a core 12 having a three-dimensional shape conforming to the interior of the outer portion 14 at step 204. The core 12, may present at least one of a surface shape and/or a coloration representing an anatomical feature of a creature attractive to fish as food. For example, the core may present an appearance of a schooling baitfish, a bottom baitfish, a crustacean, an amphibian, a worm, a grub, an insect, a spider, a leech, or another creature that is attractive to fish.

As described above, through the use of suitable silicones, polymers, and/or other materials, any or all portions of such fishing lures 10 can be wholly or partially flexible, and can be flexible in varying degrees in order to accomplished desired effects, particularly when the fishing lures 10 are in motion relative to water or other fluids.

In further aspects and embodiments, the invention provides processes of producing such lures 10 through the use of injection molding techniques; 3-D printing processes such as fused deposition modeling (FDM) and/or selective laser sintering (SLS); and or other techniques.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

What is claimed is:

1. A lure, comprising:
a core having a surface shape and coloration configured to represent an anatomy of a food for a game fish; and
an outer portion of translucent material disposed around the core, the outer portion being at least partially flexible and defining a surface adapted to cause the lure to move in conformance with a mode of transit as the lure is moved through water.

2. The lure of claim 1, wherein the core presents a three-dimensional appearance of at least one of: a schooling baitfish, a bottom baitfish, a crustacean, an amphibian, a worm, a grub, an insect, a spider, a leech, or other creature attractive to fish.

3. The lure of claim 1, wherein the surface shape and coloration of the core represents an anatomical feature of a creature.

4. The lure of claim 3, wherein the surface shape and coloration of the core comprises at least one of: paint, one or more metallic flakes or pieces, or glitter.

5. The lure of claim 1, wherein the core is formed around a rigid object.

6. The lure of claim 1, wherein the outer portion is sufficiently translucent to not significantly distort an appearance of the core when viewed in at least one of air or water.

7. The lure of claim 1, wherein the outer portion comprises at least one physical feature not comprised or represented by the core.

8. The lure of claim 1, wherein the physical feature comprises at least one of a fin, wing, tail, flange, flap or other hydrodynamic or mechanical fluid control surface.

9. The lure of claim 1, wherein the outer portion comprises coloration adapted to affect a surface appearance of at least a portion of the lure.

10. The lure of claim 9, wherein the coloration comprises at least one of paint, one or more metallic flakes or parts, or glitter.

11. The lure of claim 1, wherein at least a portion of the core is flexible.

12. The lure of claim 1, wherein at least one of the core or the outer portion comprises a soft polymer.

13. The lure of claim 1, wherein at least one of the core or the outer portion defines a durometer gradient.

14. A method of making a lure, comprising:
disposing a molding frame in a first molding device, the molding frame comprising at least a first molding support member and at least one second molding support member, the first and second molding support members being at least one of non-collinear or non-coaxial;
introducing a first material to the first molding device and solidifying the first material to form a core;
disposing the molding frame and the core in a second molding device; and
introducing a second material to the second molding device, so as to form an outer portion at least partially surrounding the core.

15. The method of claim 14, further comprising removing at least one of the molding support members from at least one of the core or the outer portion.

16. The method of claim 14, wherein the molding frame comprises a longitudinal support member and a transverse support member disposed substantially orthogonally to the longitudinal support member.

17. The method of claim 14, further comprising disposing at least one of a fish hook or a line leader in the first molding device prior to introducing the first material.

18. The method of claim 16, further comprising introducing one or more colorants to the first molding device, each of the one or more colorants having a different color to generate a surface coloration of the core, with the surface coloration representing an anatomical feature of a creature attractive to fish as food.

19. A method of making a lure, comprising:
introducing a settable material to an interior of an outer portion of flexible translucent material; and
solidifying the settable material to form a core having a three-dimensional shape conforming to the interior of the outer portion, the core presenting at least one of a surface shape or a coloration representing an anatomical feature of a creature attractive to fish as food.

20. The method of claim 19, wherein the core presents an appearance of at least one of a schooling baitfish, a bottom baitfish, a crustacean, an amphibian, a worm, a grub, an insect, a spider, a leech, or another creature attractive to fish.
